(19) United States
(12) Patent Application Publication
(10) Pub. No.: US 2010/0295230 A1
(43) Pub. Date: Nov. 25, 2010

(54) TRAY DEVICE FOR USE WITH LENS HOLDER

(75) Inventor: HSIN-CHIN HUNG, Tu-Cheng (TW)

Correspondence Address: Altis Law Group, Inc.;ATTN: Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/752,132

(22) Filed: Apr. 1, 2010

(30) Foreign Application Priority Data
May 25, 2009 (CN) 200910302604.0

(51) Int. Cl. B23Q 3/00

(52) U.S. Cl. 269/296

(57) ABSTRACT

An tray device for a lens holder during the process of vacuum coating, the lens holder comprising a base and a lens barrel, the base comprising a recessed portion and the lens barrel comprising an opening communicating with the recessed portion, the tray device comprises a main body defining a through hole and at least one hollow space extending through the main body. The main body is configured for supporting the base of the lens holder. The through hole is aligned with opening of the lens holder, wherein the at least one hollow space communicates with the recessed portion of the base of the lens holder.

### BACKGROUND

1. Technical Field

The present disclosure relates to a tray device for use with a lens holder for use during a vacuum coating process.

2. Description of Related Art

Many camera modules used in electronic devices such as digital cameras include lens holders for holding lenses. The lens holders usually have an EMI shield coating. The coating can be applied by any conventional technique such as vacuum coating. In the case of vacuum coating, the lens holders need to be positioned on a tray in a vacuum environment. The lens holder is held in position by a positioning post extending through the lens holder and the tray, which creates a closed cavity. During coating, the lens holder and the tray device will be heated. If air trapped in the cavity escapes into the vacuumized space, coating will be negatively affected.

Therefore, a tray device for use with lens holders during vacuum coating is essential to surmount the above mentioned problem.

### BRIEF DESCRIPTION OF THE DRAWINGS

The components in the drawings are not necessarily drawn to scale, the emphasis instead being placed upon clearly illustrating the principles of the tray device.

Moreover, in the drawings, like reference numerals designate corresponding parts throughout the several views.

FIG. 1 is an isometric view of a tray assembly including a plurality of tray devices in accordance with an exemplary embodiment.

FIG. 2 is an exploded planar view showing one tray device of FIG. 1, a lens holder and a positioning post.

FIG. 3 is a cross-sectional view of the assembly of FIG. 2, taken along the line III-III of FIG. 1.

### DETAILED DESCRIPTION

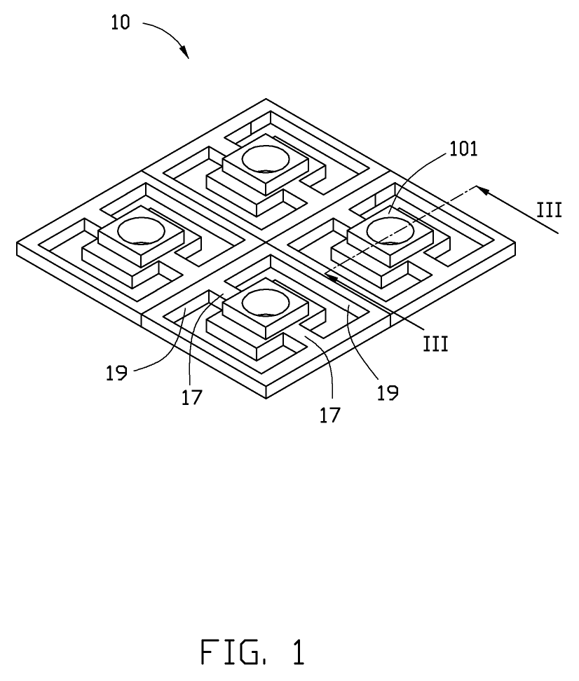

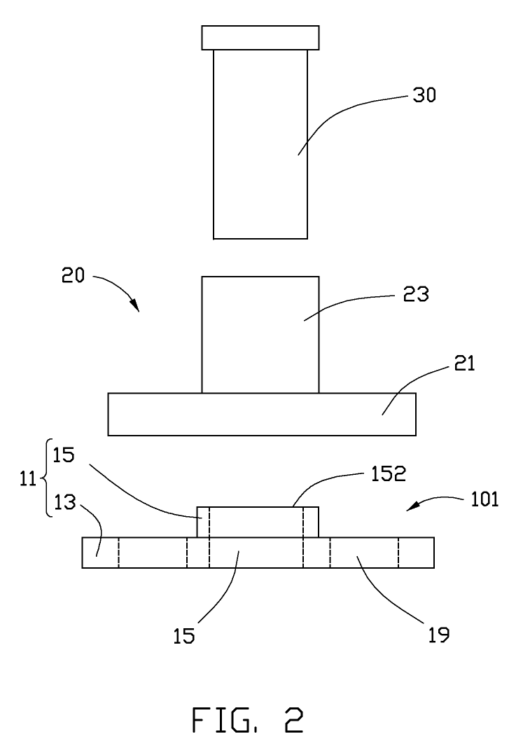

Referring to FIGS. 1 and 2, a tray assembly 10 including a plurality of tray devices 101 is disclosed. The tray device 101 is configured for supporting a lens holder 20 during vacuum coating of the lens holder 20.

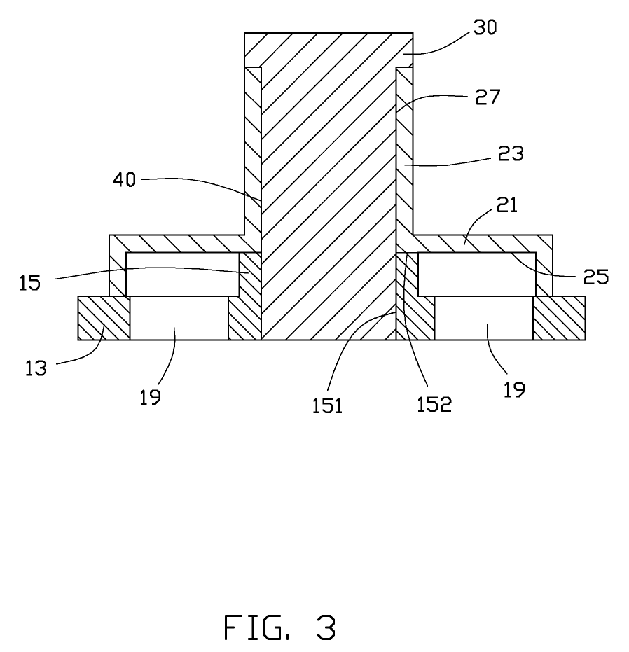

Referring also to FIG. 3, the lens holder 20 is a conventional component used in electronic imaging devices. The lens holder 20 includes a base 21 and a lens barrel 23. A recessed portion 25 is defined in the bottom of the base 21. The lens barrel 23 is used to hold a lens (not shown) and defines an opening 27 along the length of the lens barrel 23. The opening 27 communicates with the recessed portion 25.

The tray device 101 includes a main body 11 that can be made of plastic material. The main body 11 includes a hollow frame 13 and a central portion 15. In the exemplary embodiment, the frame 13 and the central portion 15 are integrally formed. The central portion 15 is disposed within the hollow frame 13. The central portion 15 is connected to the main body 11 by a pair of tabs 17 (shown in FIG. 1), forming two hollow spaces 19 between the hollow frame 13 and the central portion 15. The tabs 17 are formed opposite to each other to extend from the frame 13 to the central portion 15.

A through hole 151 is formed in the central portion 15. In the exemplary embodiment, the through hole 151 and the opening 27 in the lens barrel 23 are both circular and have the same diameter. The central portion 15 also includes a top surface 152, bounding the through hole 151. The top surface 152 is formed higher than the frame 13.

When starting to position the lens holder 20 to the tray device 101, the opening 27 in the lens barrel 23 is aligned with the through hole 151 by an auxiliary positioning device (not shown). A positioning post 30 is then inserted into the opening 27 and the through hole 151. The positioning post 30 is formed in such a way that it accurately positions and holds stationary the lens holder 20.

After positioning of the lens holder 20, the top surface 152 of the central portion 15 makes airtight contact with a bottom surface 251 of the recessed portion 25 and a periphery of the recessed portion 25 makes airtight contact with the frame 13. The recessed portion 25 thus communicates with the hollow spaces 19. With such arrangement, the air within the recessed portion 25 can be pumped out through the hollow spaces 19 creating a vacuum.

While one embodiment has been described and illustrated, the disclosure is not to be construed as being limited thereto. Those skilled in the art, can make various modifications to the embodiments without departing from the true spirit and scope of the disclosure as defined by the appended claims.

What is claimed is:

1. A tray device for a lens holder during vacuum coating, the lens holder comprising a base and a lens barrel, the base comprising a recessed portion and the lens barrel comprising an opening communicating with the recessed portion, the tray device comprising:
a main body defining a through hole and at least one hollow space extending through the main body, the main body being configured for supporting the base of the lens holder, the through hole being aligned with opening of the lens holder, wherein the at least one hollow space communicates with the recessed portion of the base of the lens holder.

2. The tray device according to claim 1, wherein the tray device is made of plastic.

3. The tray device according to claim 1, wherein the opening in the lens barrel and the through hole in the main body has the same shape and size.

4. The tray device according to claim 3, wherein the opening in the lens barrel and the through hole in the main body are round.

5. The tray device according to claim 1, wherein the main body comprises a hollow frame and a central portion, the central portion is disposed within the hollow frame, the at least one hollow space is formed between the hollow frame and the central portion, the through hole is formed in the central portion.

6. The tray device according to claim 5, wherein the central portion is connected to the frame by two tabs extending between the central portion and the frame.

7. The tray device according to claim 6, wherein the two tabs is formed opposite to each other.

8. The tray device according to claim 5, wherein the central portion is integrally formed with the frame.

9. The tray device according to claim 5, wherein the central portion comprises a top surface that is formed higher than the frame, the top surface engages a bottom surface of the recessed portion.

10. The tray device according to claim 5, wherein the lens holder is removably connected to the tray device by a positioning post mating with the opening of the lens barrel and the through hole of the main body.
